(19) United States
(12) Patent Application Publication
(10) Pub. No.: US 2007/0092688 A1
(43) Pub. Date: Apr. 26, 2007

(54) Polyurethane coating system

(76) Inventors: Van I. Doesburg, Dalton, GA (US); Jeffrey Wayne Manning, Chattanooga, TN (US)

Correspondence Address: KING & SPALDING LLP, 1180 PEACHTREE STREET, ATLANTA, GA, 30309-3521, US

(21) Appl. No.: 11/586,438

(22) Filed: Oct. 24, 2006

Related U.S. Application Data
(60) Provisional application No. 60/730,552, filed on Oct. 24, 2005.

(51) Int. Cl. B32B 37/00

(52) U.S. Cl. 428/95; 428/304.4; 156/78; 156/543

(57) ABSTRACT

The present invention relates to a method and apparatus for forming a layer of blown cellular polyurethane foam on a textile material, such as a carpet backing. The method includes applying to a textile material a layer of reactive polyurethane forming agents, heating the layer so as to cause chemical blowing of the mixture and applying to the layer during the chemical blowing thereof a thermal insulating blanket for a time sufficient to control the blowing of the mixture to a desired degree. Apparatus for performing the process is also disclosed.

### CROSS-REFERENCE TO RELATED APPLICATIONS

This application claims the benefit of provisional application Ser. No. 60/730,552 filed Oct. 24, 2005.

### FIELD OF THE INVENTION

The present invention relates generally to a method and apparatus for forming a layer of mechanically frothed and chemically blown cellular polyurethane foam on a textile material, such as a carpet backing. More specifically, the present invention relates to a method and apparatus for providing improved control of properties, such as bond strength, gauge control and foam density, for foams blown by chemical processes.

### BACKGROUND OF THE INVENTION

U.S. Pat. Nos. 4,132,817; 4,171,395; 4,405,393; 4,512,831; 4,715,912 (the disclosures of which are all incorporated herein by reference) disclose apparatus and processes by which a layer of blown cellular polyurethane; i.e., polyurethane foam, can be formed on a textile material, such as a textile fabric or a carpet back. These processes have been used commercially for many years. In the system disclosed in the above-referenced patents, when a relatively heavy blanket weight is applied to the expanding polyurethane reactants, the density of the foam increases and gauge; i.e., foam thickness, is difficult to control. With no blanket weight, the foam and fabric bond is inhibited due to inconsistent contact between the fabric and foam, while at the same time creating a gauge control problem. Furthermore, changes in line speed; i.e., conveyor belt speed, can also influence bond and gauge control.

U.S. Pat. Nos. 3,821,130 and 4,696,849 (the disclosures of which are all incorporated herein by reference) teach the art of forming a cellular polyurethane backing by mechanical frothing and U.S. Pat. No. 6,790,872 (the disclosure of which is incorporated herein by reference) claims the use of an additional chemical blowing agent to reduce the density of the cured polyurethane. Normal practice in the art is to pass the uncured foaming composition through a hot air oven to heat the chemical composition whereby blowing and curing is accomplished. These methods suffer the same problems of inconsistent density, gauge control, bond strength and incomplete curing of the foam.

Surprisingly, it has been found that replacing the hot air oven with a thermal insulating blanket provides superior blowing, evenness of gauge, improved cure and relatively low density foam.

### SUMMARY OF THE INVENTION

The present invention relates to a method for forming a layer of mechanically frothed and chemically blown cellular polyurethane on a textile material, such as a carpet backing. The method includes applying to a textile material a mechanically frothed layer of reactive polyurethane forming agents containing a sufficient amount of blowing agent so as to cause chemical blowing of the mixture when heated sufficiently, heating the layer under controlled conditions so as to cause chemical blowing of the frothed mixture and applying to the layer during the chemical blowing thereof a thermal insulating blanket to control the blowing of the mixture to a desired degree.

In another embodiment, there is an apparatus for forming a layer of mechanically frothed and chemically blown cellular polyurethane on a textile material. The apparatus comprises a conveyor upon which a quantity of reactive polyurethane forming agents can be deposited, a mixer for frothing reactive polyurethane forming agents and for depositing the frothed composition on the conveyor, apparatus for applying a textile or scrim material to the upper surface of the frothed polyurethane forming agents deposited on the belt, a heater for heating the frothed polyurethane forming agents deposited on the belt to cause chemical blowing thereof, and a thermal insulating blanket for application to the frothed polyurethane forming agents during the chemical blowing thereof.

Accordingly, it is an object of the present invention to provide an improved method and apparatus for forming a layer of mechanically frothed and chemically blown cellular polyurethane on a textile material; particularly, a carpet back.

Another object of the present invention is to provide a method and apparatus for forming a layer of mechanically frothed and chemically blown cellular polyurethane on a textile material without the use of a hot air oven to initiate and control the blowing reaction.

A further object of the present invention is to provide a method and apparatus for forming a layer of mechanically frothed and chemically blown cellular polyurethane on a textile material that has improved properties, such as evenness of gauge, improved bond strength, improved cure and low density.

Yet another object of the present invention is to provide a method and apparatus for forming a layer of mechanically frothed and chemically blown cellular polyurethane on a textile material that is more energy efficient than prior art processes using hot air ovens.

A further object of the present invention is to provide a method and apparatus for forming a layer of cellular polyurethane foam on a textile fabric, wherein the foam has both an even gauge and a relatively low density.

These and other objects, features and advantages of the present invention will become apparent after a review of the following detailed description of the disclosed embodiments and the appended drawing and claims.

### BRIEF DESCRIPTION OF THE DRAWING

FIG. 1 is a schematic diagram of a disclosed embodiment of an apparatus for forming a layer of mechanically frothed and chemically blown cellular polyurethane on a carpet backing fabric in accordance with the present invention.

FIG. 2 is a partial detailed schematic view of the thermal blanket portion of the apparatus shown in FIG. 1.

FIG. 3 is a partial detailed schematic view of an alternate embodiment of the thermal insulating blanket portion of the apparatus shown in FIG. 1, showing the introduction of the fabric over the face of the doctor blade.

### DETAILED DESCRIPTION OF THE DISCLOSED EMBODIMENTS

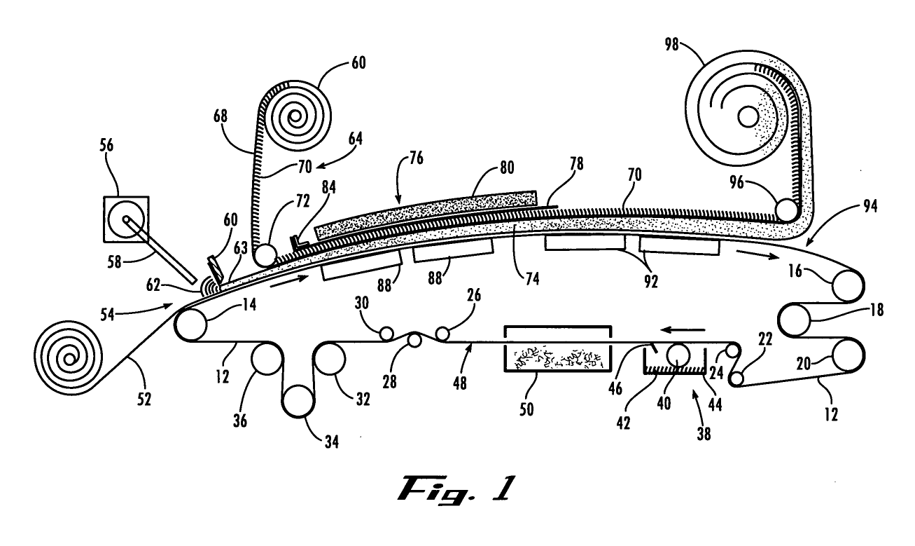

Referring now in more detail to the drawing in which like number indicate like elements throughout the several views, there is shown an apparatus 10 for forming a layer of cellular foam on a textile fabric material. The apparatus 10 comprises an endless conveyor belt 12 extending along an endless conveyor path over the rollers 14, 16, 18 and 20 of which some are driven by an electric motor (not shown), the idler rollers 22 and 24, the belt guide rollers 26, 28 and 30 and the belt tensioning rollers 32, 34 and 36 (FIG. 1). The belt 12 moves in a continuous loop in the direction shown by the arrows (FIG. 1). The speed of the belt 12 is variably controllable to adjust to varying manufacturing needs. Generally, for producing carpet, belt speeds that are useful in the present invention are preferably about 8 to about 80 feet per minute, especially about 10 to about 60 feet per minute. Other speeds can also be used depending on the product that is being manufactured.

From the drive roller 16, the conveyor belt 12, which preferably is constructed from fiberglass coated with a low coefficient of friction coating, such as Teflon® (polytetrafluoroethylene), passes around the drive rollers 18 and 20. The belt 12 is delivered by the idler rollers 22 and 24 and then to an optional film coating station 38 comprising an applicator roller 40 partially submerged in a liquid elastomeric composition mixture 42 in a trough 44. The mixture preferably comprises an ethylene vinyl acetate latex, surfactants, a thickener, a flame retardant and an internal lubricant. A doctor blade 46 is positioned downstream of the applicator roller 40 to control the thickness of the film as it is coated onto the belt 12 by wiping off any excess which then flows down the blade back into the trough 44. The film 48 on the coated belt 12 is then dried in a circulating hot air dryer 50. The dried elastomeric film has a thickness of about 0.0005 inches to about 0.002 inches, preferably about 0.001 inch and a weight per square yard of about 0.4 ounces to about 2 ounces, preferably about 0.9 ounces. Alternately, the optional elastomeric film 48 can comprise a layer of an olefin material, such as polyethylene or polypropylene, or a layer of polyvinyl chloride or rubber lattices, such as natural or synthetic styrene-butadiene rubber (SBR) latex. In addition, the elastomeric film can be extruded onto the belt rather than formed in situ. Alternately, a light weight fabric or nonwoven scrim 52 can be substituted for the optional elastomeric film 48 by laying the fabric or scrim onto the belt 12 as it passes around the roller 14.

From the drier 50, the belt 12 with the dried elastomeric film 48 thereon is then passed over the belt guide rollers 26, 28 and 30 to properly position the belt in preparation for polyurethane deposition. Then, the belt 12 is passed over the belt tensioning rollers 32, 34 and 36 and back to the roller 14.

Downstream from the roller 14 is a frothed polyurethane deposition station 54. The polyurethane deposition station 54 includes a suitable commercial frothing machine 56 having its discharge hose 58 extending above the conveyor belt 12. Polyurethane frothing machines are well known in the art, such as an Oakes mechanical frother available from E.T. Oakes Corp. The frothing machine 56 produces a mechanically frothed uncured foam of polyurethane reactants.

The polyurethane reactants comprise at least one polyol, at least one isocyanate, water, or a heat-sensitive blowing agent, so as to cause chemical blowing of the mixture when heated sufficiently and a surfactant are continuously charged into the frothing machine 56. Preferably the polyurethane reactants contain a sufficient amount of water so as to cause chemical blowing of the mixture when heated sufficiently. The polyurethane reactants and the mixer 56 are cooled so that the temperature of the mixed reactants, as they emerge from the mixer, can be maintained at a temperature of about 40° to about 100° F., preferably about 70° F. so as to delay chemical blowing until after the frothed polyurethane mixture is shaped into a layer of desired thickness.

The polyurethane reactants are preferably frothed to a density of about 16 to about 30 pounds per cubic foot; especially, about 18 to about 30 pounds per cubic foot; specifically, about 18 pounds per cubic foot. A polyurethane formulation suitable for use in the present invention is disclosed in U.S. Pat. No. 6,790,872 (the disclosure of which is incorporated herein by reference).

In order to assure a uniform lay down of the polyurethane reactants onto the conveyor belt 12, the end of the hose 58 is positioned about 0.25 inch to about 6 inches, preferably about 2.0 inches above the belt. Additionally, the centerline of the hose 58 is positioned about 1 inch to about 10 inches, preferably about 3 inches, upstream from a spreading device or doctor blade 60.

The frothed polyurethane reactants are deposited on the film-coated belt 12, or optionally on the scrim 52, in an amount such that they form a puddle or rolling bank 62 in front of the doctor blade 60. The deposited frothed polyurethane reactant mixture is then smoothed and spread into a reactive layer 63 of uniform thickness by a doctor blade 60 positioned at a desired distance above the conveyor belt 12. The frothed polyurethane reactant mixture is preferably formed into a layer of about 0.07 to about 0.5 inches thick; especially, about 0.125 to about 0.5 inches thick.

Simultaneously with the deposition of the frothed polyurethane reactants onto the conveyor belt 12, or optional scrim 52, a textile fabric, such as a carpet 64 of conventional tufted construction, is dispensed from a supply roll 66. The tufted carpet 64 includes a backing fabric 68 and outwardly extending yarns 70 which forms the face pile of the carpet. Alternately, the carpet 64 can be of a woven construction, or a light weight nonwoven fabric, including a nonwoven fiberglass fabric. The textile fabric can be of a woven, nonwoven or knitted construction and can be made from natural or synthetic fibers or a blend thereof. The carpet 64 is then fed under a marriage bar 72 to tension and marry the fabric or carpet 64 to the layer 63 of frothed polyurethane reactants.

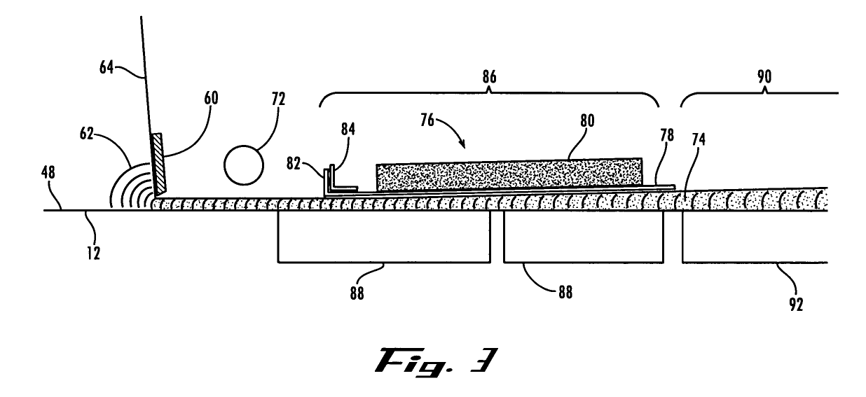

Alternately, the textile fabric or carpet 64, if smooth enough, can be passed along the face of the doctor blade 60 where it is then drawn under the doctor blade and becomes the upper surface of the uncured foam cushion 74 (FIG. 3).

Immediately after the textile fabric or carpet 64 is applied to the frothed partially reacted polyurethane, it is necessary to press the backing fabric 68 of the carpet 64 against the frothed reactants with a force of about 0.02 ounces to 5 ounces, preferably about 0.025 ounce to 2 ounces per square inch, for part or all of the time that gas is being evolved by the reactive mixture, i.e., about 1 to 200 seconds, preferably about 10 to 180 seconds. This is accomplished by drawing the ladened belt; i.e., the belt 12 with the frothed polyurethane reactant layer 63 and carpet 64 thereon, under a thermal insulating blanket 76. The thermal insulating blanket 76 preferably comprises a low coefficient of friction fabric 78, or a fabric with a low coefficient of friction coating, such as nonwoven or woven fiberglass coated with Teflon® (polytetrafluoroethylene), which rides over the face pile yarn 70 of the carpet 64. A layer of thermal insulating material 80, preferably a material with an R-value of greater than or equal to about 2, especially a fiberglass batting, such as fiberglass insulation, is disposed on top of the low friction fabric 78. The thermal insulating material 80 preferably has a density of about 0.5 to about 24 pounds per cubic foot and a thickness of about 0.25 to about 4 inches. The thermal insulating material 80 provides an especially preferred heat insulation R-value of about 2 to about 30; most especially, about 3 to about 14. It is specifically contemplated that other soft, insulating materials also can be used for the thermal insulating blanket 76, such as latex foams, polyurethane foams, polystyrene foams, and the like, as long as they provide comparable insulating R-values and weights.

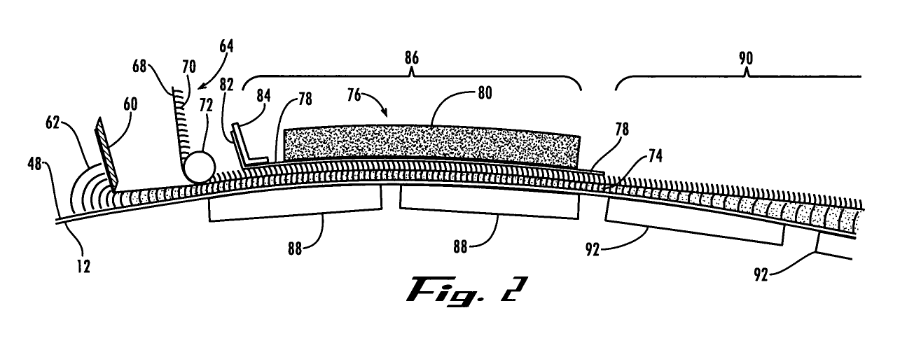

The low friction fabric 78 is fastened at one end 82 (FIGS. 2 and 3) to a stationary bracket 84 so that the thermal insulating blanket 76 is applied to the carpet 64 or textile fabric immediately after the carpet or textile fabric is applied to the layer 63 of polyurethane reactants.

With reference to FIG. 2, it can be seen that there is gas evolution section as indicated at 86. The gas evolution section 86 is the portion of the manufacturing process during which the frothed polyurethane reactants produce gas to reduce the density of the foam; i.e., experience chemical blowing, as opposed to merely curing the frothed reactants. During the time that the reactants are evolving gas, it is most important to control their temperature in order to prevent collapse of the foam, maximize the chemical blowing reaction and control the gauge to produce a foam of uniform thickness. This is done by controlling the temperature of the reactant heaters 88 and applying a thermal insulating blanket 76 which retains the applied heat and the exothermic heat evenly within the expanding frothed polyurethane reactants so that the reactants are raised to a temperature of about 120° to 290° F.; preferably, about 160° to 275° F., and held at that temperature for a period of about 10 seconds to 240 seconds; preferably, about 50 seconds to about 180 seconds. The thermal insulating blanket 76 extends from approximately the beginning of the gas evolution section 84 to approximately the end of that section.

Preferably the chemical blowing of the frothed polyurethane reactants further reduces the density thereof to about 8 to about 12 pounds per cubic foot; especially, about 10 to about 12 pounds per cubic foot.

After completion of gas evolution, the foam-backed textile fabric or carpet 64 is heated for an additional time to affect the desired cure of the polyurethane foam in a curing section 90. This is accomplished by passing the carpet and foam ladened belt 12 over the cure heaters 92 which raise the temperature of the foam sufficiently to cure the foam, such as about 150° to 350° F.; preferably about 250° to 300° F.

Finally, the textile fabric or carpet 64, together with the attached mechanically frothed and chemically blown cellular polyurethane layer and elastomeric film, is stripped from the belt at the exit 94, fed over a stripper roller 96 and rolled onto a take-up reel 98.

With reference to FIG. 3, details of the thermal insulating blanket 76 are again demonstrated, but with the textile fabric or carpet 64 introduced over the face of the doctor blade 60. In this embodiment, the textile fabric or carpet 64 is introduced to the deposited frothed reactant layer 63 by passing the textile fabric or carpet over the face of the doctor blade 60 where it is then drawn under the blade and covers the upper surface of the uncured frothed polyurethane reactants layer.

The following examples are illustrative of the present invention and are not intended to limit the scope of the invention as set forth in the appended claims.

### EXAMPLE 1

A carpet is prepared using a laboratory scale apparatus as described above.

The belt speed is held constant at 4 feet per minute. Another variable kept constant is the marriage point between the carpet 24 and the polyurethane reactants layer 63. A nonwoven fiberglass fabric, having a weight of 2.3 ounce per square yard, is passed along the face of the doctor blade 60 and passes below the tip of the doctor blade to form the upper surface of the uncured mechanically frothed polyurethane layer 63.

The polyurethane composition used in this example contains at least one polyol, at least one isocyanate, water, a surfactant and a suitable catalyst. The formula for this composition is set forth below in Table 1.

TABLE 1

| Ingredient | Parts by Weight |
|---|---|
| Isocyanate (Papi 94) | 43.19 |
| Voranol 9137 | 95.00 |
| Diethylene glycol | 5.00 |
| Calcium carbonate (filler) | 150.00 |
| Water | 1.00 |
| Catalyst | 0.02 |
| L-5614 (silicone surfactant) | 1.00 |

In Table 1 above, Papi 94 is a polymeric MDI (polymethylene polyphenylisocyanate that contains MDI), available from Dow Chemical Company; Voranol 9137 is a polyol available from Dow Chemical Company; diethylene glycol is available from M.E. Global International; calcium carbonate is available from Georgia Marble and L-5614 is a silicone surfactant available from General Electric.

These reactants are introduced into an Oakes mechanical frother 56 (commercially available from E.T. Oakes Corp.) where compressed nitrogen gas is added and mechanically combined to form a reactive uncured polyurethane froth having a density of 18 pounds per cubic foot. This composition is identified for this example as composition A.

Test Conditions:

The reactant heaters 88 are set at 250° F. The cure heaters 92 are set at 300° F. The doctor blade is set at 0.175 inches above the belt 12.

Test #1:

The nonwoven fiberglass fabric is married with Composition A and processed as described above, except that the composition passes through the gas evolution section 86 and through the curing section 90 without a thermal insulating blanket 78 and without passing through a hot air oven.

Test #2:

The nonwoven fiberglass fabric is married with Composition A and processed as described above; i.e., the composition passes through the gas evolution section 86 and the curing section 90 with the use of a thermal insulating blanket 76 covering fabric and layer of polyurethane reactants 63 while in the gas evolution section. The thermal insulating blanket 76 is constructed of a first layer of Teflon® coated fiberglass, conveyor belting fabric style 313, available from Saint-Gobain Inc. and a second layer of a 0.5 inch polyurethane foam having a density of 0.5 pounds per cubic foot and an R-value of 2.

Test #3:

The nonwoven fiberglass fabric is married with Composition A and processed as described above, except that the composition passes through the gas evolution section 86 with the addition of a hot air oven maintained at 250° F. surrounding the gas evolution section and no thermal insulating blanket is used.

Test Results:

The results of these tests is shown below in Table 2.

TABLE 2

| Property | Test #1 | Test #2 | Test #3 |
|---|---|---|---|
| Foam thickness | 0.215 | 0.350 | 0.333 |
| Foam density | 16.4 pcf | 9.2 pcf | 11.5 pcf |
| Foam uniformity | uneven gauge | even gauge | Uneven gauge |

Pcf = pounds per cubic foot

### EXAMPLE 2

The same procedure is followed as in Test #2 of Example 1 above, except a fiberglass bat is substituted for the polyurethane foam in the thermal blanket. The fiberglass bat has a thickness of 3.5 inches, a density of 0.85 pounds per cubic foot and an R-value of 13.

A polyurethane foam having relatively low foam density and even gauge is produced.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A method of forming a layer of cellular polyurethane foam on a textile material comprising:
applying to the textile material a mechanically frothed layer of a composition comprising reactive polyurethane forming agents, a surfactant and a blowing agent;
heating the frothed layer of the composition so as to cause chemical blowing thereof;
applying to the layer of the composition during the chemical blowing thereof a thermal insulating blanket having an insulation R-value of greater than or equal to 2.

2. The method of claim 1, wherein the textile material is a carpet.

3. The method of claim 1, wherein the textile material is nonwoven fiberglass.

4. The method of claim 1, wherein the textile material is a textile fabric.

5. The method of claim 1, wherein the thermal insulating blanket is a layer of fiberglass.

6. The method of claim 1, wherein the thermal insulating blanket is a layer of polyurethane foam.

7. The method of claim 1, wherein the thermal insulating blanket is a first layer of fabric having a low coefficient of friction and a second layer of fiberglass.

8. The method of claim 7, wherein the first layer is a layer of woven or nonwoven fiberglass having a low coefficient of friction coating thereon.

9. The method of claim 8, wherein the low coefficient of friction coating is polytetrafluoroethylene.

10. The method of claim 1, wherein the thermal insulating blanket is applied immediately after the textile is married into the composition layer.

11. The method of claim, 1 wherein the thermal insulating blanket applies a pressure of about 0.02 to about 5 ounces per square inch to the textile material.

12. The method of claim 1, wherein the pressure is insufficient to undesirably reduce the gauge of the foam.

13. The method of claim, 1 wherein the layer of the composition is mechanically frothed before it is applied to the textile material.

14. The method of claim, 1 wherein the insulation R-value of the thermal blanket is about 2 to about 30.

15. Apparatus comprising:
a conveyor;
a frothing apparatus for mechanically frothing polyurethane reactants and depositing them on the conveyor;
a textile fabric feeder for feeding a textile fabric onto the frothed layer of polyurethane reactants on the conveyor;
a heater disposed below the conveyor for heating the frothed layer of polyurethane reactants on the conveyor; and
a thermal insulating blanket disposed above the conveyor and positioned so that the textile fabric and frothed layer of polyurethane reactants pass under the thermal insulating blanket and in contact therewith while the frothed layer of polyurethane reactants is evolving gas, said thermal insulating blanket having an R-value of greater than or equal to 2.

16. The apparatus of claim 15, wherein the thermal insulating blanket is a layer of fiberglass.

17. The apparatus of claim 15, wherein the thermal insulating blanket is a layer of polyurethane foam.

18. The apparatus of claim 15, wherein the thermal insulating blanket is a first layer of fabric having a low coefficient of friction and a second layer of fiberglass insulation.

19. The apparatus of claim 18, wherein the first layer is a layer of woven or nonwoven fiberglass having a low coefficient of friction coating thereon.

20. The apparatus of claim 19, wherein the low coefficient of friction coating is polytetrafluoroethylene.

21. The apparatus of claim 15, wherein the mixer is a mechanical frother.

22. The apparatus of claim 15, wherein the thermal blanket provides an R-value of about 2 to about 30.

23. A textile fabric made by the method of claim 1.

24. A carpet made by the process of claim 1.

25. The carpet of claim 24, wherein the layer of cellular polyurethane foam has a density of about 8 to about 12 pounds per cubic foot.

26. The carpet of claim 24, wherein the layer of cellular polyurethane foam has a density of about 10 to about 12 pounds per cubic foot.

27. The carpet of claim 24, wherein the layer of cellular polyurethane foam has an even gauge.
